(19) United States
(12) Patent Application Publication
(10) Pub. No.: US 2025/0015996 A1
(43) Pub. Date: Jan. 9, 2025

(54) INFORMATION PROCESSING SYSTEM AND METHOD AND NON-TRANSITORY COMPUTER READABLE MEDIUM

(71) Applicant: FUJIFILM Business Innovation Corp., Tokyo (JP)

(72) Inventor: Tsuyoshi WATANABE, Kanagawa (JP)

(73) Assignee: FUJIFILM Business Innovation Corp., Tokyo (JP)

(21) Appl. No.: 18/424,865

(22) Filed: Jan. 29, 2024

(30) Foreign Application Priority Data
Jul. 7, 2023 (JP) 2023-112093

(51) Int. Cl. H04L 9/32

(52) U.S. Cl. CPC H04L 9/3213; H04L 9/3234

(57) ABSTRACT

An information processing system includes at least one processor configured to: link a token to be used for accessing a service with identification information for identifying the service and manage the token and the identification information linked with each other; and return, when a request for a token is received from an external device, the request including identification information of a specified service, and if a valid token of the specified service is stored, a reply including the token of the specified service.

### CROSS-REFERENCE TO RELATED APPLICATIONS

This application is based on and claims priority under 35 USC 119 from Japanese Patent Application No. 2023-112093 filed Jul. 7, 2023.

### BACKGROUND

### (i) Technical Field

The present disclosure relates to an information processing system and method and a non-transitory computer readable medium.

### (ii) Related Art

From the viewpoint of implementing single sign-on (SSO) and improving the security, for example, modern authentication, such as authentication using OAuth authorization (hereinafter may also be called OAuth authentication), is being utilized.

Japanese Patent No. 6873642 discloses the following image forming device. The image forming device includes a selector, first and second user authentication units, and a sender. The selector selects an access token to be used for a user authenticated by the first user authentication unit from among access tokens managed by an access token manager. The second user authentication unit performs user authentication with an external server by using the selected access token. After the second user authentication unit has performed user authentication, the sender sends an image file to a destination by using a function of the external server.

Japanese Patent No. 5831480 discloses the following mobile information terminal apparatus. The mobile information terminal apparatus includes an obtainer and a requestor. The obtainer causes an information device, which is shared by plural users, to obtain an access token and also obtains this access token. The requestor sends the access token to the information device when making a request for executing service processing so as to cause the information device to perform data communication, which is performed in response to a request for executing service processing, with a service use system.

### SUMMARY

In modern authentication, such as OAuth authentication, an external device presents an access token obtained based on authentication settings set with an authorization server to a service server/provider. When the presented access token is found to be valid, the external device is able to access a service provided by the service server/provider.

There is a mode in which an external device obtains an access token directly from an authorization server based on authentication settings set between the external device and the authorization server. In this mode, it is necessary to set authentication settings with the authorization server for each external device which uses a service. Hence, when a user wishes to use a service in plural external devices, for example, he/she is required to do work for setting authentication settings with the authorization server in each external device and to cause each external device to obtain an access token. This is time- and effort-consuming.

Aspects of non-limiting embodiments of the present disclosure relate to the reducing of time and effort required for an external device to obtain an access token, compared with the configuration in which an access token is obtained based on authentication settings set between an external device and an authorization server.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including at least one processor configured to: link a token to be used for accessing a service with identification information for identifying the service and manage the token and the identification information linked with each other; and return, when a request for a token is received from an external device, the request including identification information of a specified service, and if a valid token of the specified service is stored, a reply including the token of the specified service.

### BRIEF DESCRIPTION OF THE DRAWINGS

Exemplary embodiments of the present disclosure will be described in detail based on the following figures, wherein:

FIG. 1 is a schematic diagram illustrating an example of the configuration of a service use system;

FIG. 2 is a block diagram illustrating an example of the hardware configuration of a user terminal;

FIG. 3 is a block diagram illustrating an example of the hardware configuration of an external device;

FIG. 4 is a block diagram illustrating an example of the functional configuration of a user terminal to which a first exemplary embodiment is applied;

FIG. 5 illustrates an example of an information management table;

FIG. 6 is a block diagram illustrating an example of the functional configuration of the external device;

FIG. 7 is a sequence diagram illustrating an example of the operation of a service use system;

FIG. 8 is a flowchart illustrating an example of the operation for providing an access token by the user terminal to which the first exemplary embodiment is applied; and

FIG. 9 is a flowchart illustrating an example of the operation for providing an update token by a user terminal to which a second exemplary embodiment is applied.

### DETAILED DESCRIPTION

As exemplary embodiments of the disclosure, first and second exemplary embodiments will be described below in detail with reference to the accompanying drawings. When it is not necessary to distinguish the first and second exemplary embodiments from each other, such as when an explanation is given of the same configuration for the first and second exemplary embodiments, the first and second exemplary embodiments may simply be referred to as the exemplary embodiment.

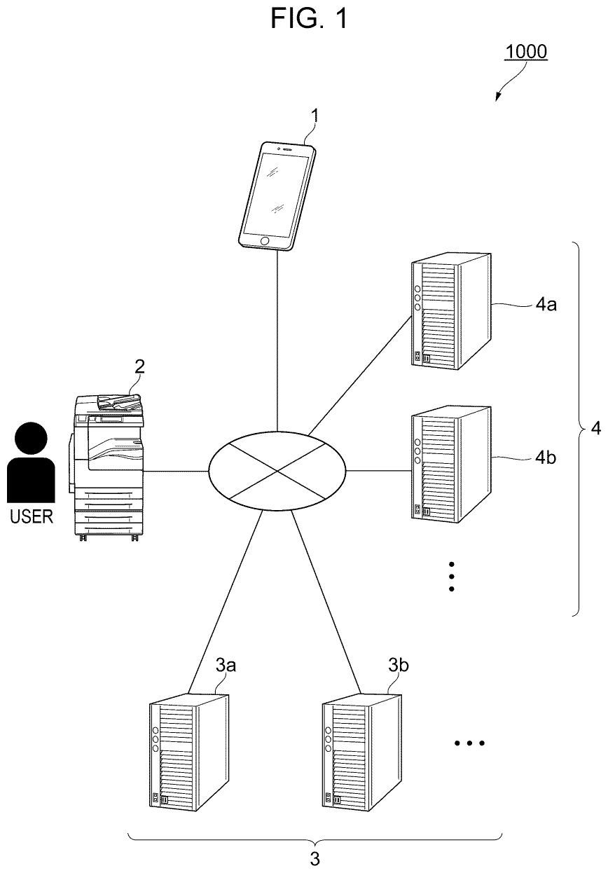

A description will first be given of the first exemplary embodiment with reference to FIGS. 1 through 7.

### First Exemplary Embodiment

### [Service Use System 1000]

FIG. 1 illustrates an example of the configuration of a service use system 1000.

As illustrated in FIG. 1, the service use system 1000 includes a user terminal 1, an external device 2, authorization servers 3 (3a, 3b, . . . ), and service servers 4 (4a, 4b, . . . ). The user terminal 1, external device 2, authorization servers 3, and service servers 4 are connected to each other via a network. The network is not restricted to a particular type if it can be used for data communication between the user terminal 1, external device 2, authorization servers 3, and service servers 4. Hereinafter, the authorization servers 3 (3a, 3b, . . . ) will be simply called the authorization server 3 unless it is necessary to distinguish them from each other, and the service servers 4 (4a, 4b, . . . ) will be simply called the service server 4 unless it is necessary to distinguish them from each other.

The service use system 1000 is a computer system that allows the external device 2 to use a service provided by the service server 4. More specifically, when, in the service use system 1000, the external device 2 makes a request for the use of a service of the service server 4 or for access to the service server 4, it presents an access token obtained based on authentication settings set with the authorization server 3 to the service server 4. If the access token presented by the external device 2 is found to be valid, the service server 4 provides a service to the external device 2.

The access token is a token to be presented to the service server 4 by a user to access a service provided by the service server 4 and is unique information created by the authorization server 3 based on authentication settings. The access token is given as several tens of digits of alphanumeric characters, for example.

A validity period is set for the access token, and if the access token presented by a user has already expired, the service server 4 does not authorize this user to use a service of the service server 4. The validity period for the access token is set to one to several hours, for example.

An update token is a token to be presented to the authorization server 3 by a user to obtain an access token and is unique information created by the authorization server 3 based on authentication settings. In a specific example, when the user terminal 1 or the external device 2 presents an update token to the authorization server 3, the authorization server 3 issues a new access token corresponding to this update token. The update token may also be called a refresh token.

A validity period may be set for the update token, and if the update token presented by a user has already expired, the authorization server 3 does not issue an access token. The validity period for the update token is set to one to several months, for example. The validity period may be updated (extended) in response to a request from a user.

Each of the access token and the update token is an example of a token used for accessing a service.

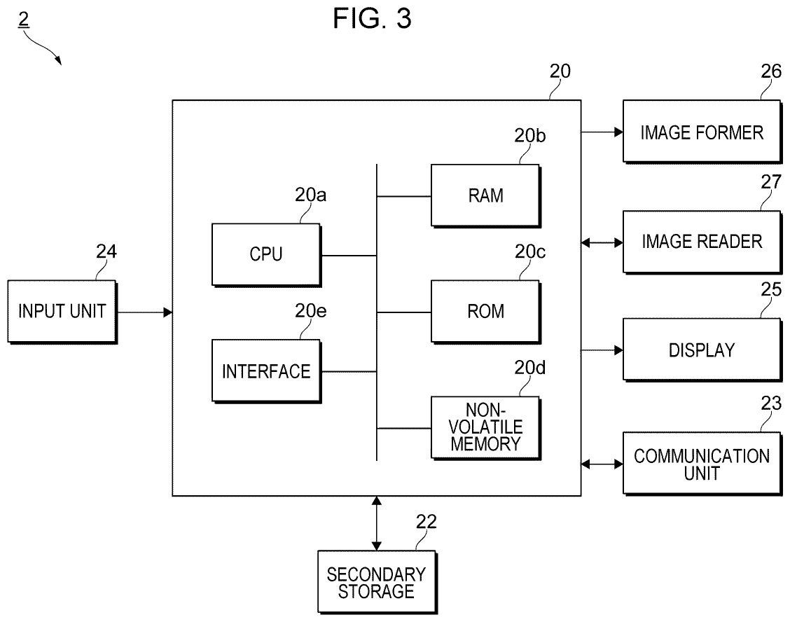

There is a mode in which the external device 2 obtains an access token directly from the authorization server 3, based on authentication settings set between the external device 2 and the authorization server 3. In this mode, if a user uses plural external devices 2, for example, he/she is required to set authentication settings with the authorization server 3 in each external device 2, which is time-consuming. Additionally, after a user has obtained an access token by setting authentication settings with the authorization server 3, if the user intends to obtain another access token by using similar authentication settings later, he/she is required to store information on these authentication settings in each external device 2, which takes up the storage space of each external device 2, such as the space of a secondary storage 22, which will be discussed later with reference to FIG. 3.

To address this issue, in the exemplary embodiment, authentication settings are set between the user terminal 1 and the authorization server 3, and the user terminal 1 obtains an access token and/or an update token from the authorization server 3 and provides them to the external device 2.

The user terminal 1 is a device which provides an access token and/or an update token of a specified service to the external device 2 in response to a request from the external device 2. In the example in FIG. 1, only one user terminal 1 is shown, but plural user terminals 1 may be provided. More specifically, if multiple users use the service use system 1000, plural user terminals 1 used by each user may be provided. In the exemplary embodiment, it is assumed that each user uses only one user terminal 1, for example.

As the user terminal 1, various computer devices (information processing devices) may be used. Specific examples of the user terminal 1 are a smartphone and a tablet terminal. The user terminal 1 may be constituted by one computer or by plural computers.

The user terminal 1 is an example of an information processing system to which the first exemplary embodiment is applied.

The external device 2 is a device used by a user. The external device 2 executes various types of processing by utilizing a service provided by the service server 4 in accordance with an instruction from a user.

“External device” means a device disposed outside the service server 4 (device which is not included in the configuration of the service server 4) and, when the device uses a service provided by the service server 4, it is requested to perform certain authentication, such as OAuth authentication.

In the exemplary embodiment, an explanation will be given, assuming that, for example, the external device 2 is an image processing device that can execute processing, such as reading (scanning) an image formed on a recording medium and forming (printing) an image on a recording medium. However, the external device 2 is not limited to an image processing device. Various other types of devices that include a computer as a controller and use a service provided by the service server 4 may be used as the external device 2.

The authorization server 3 is a server that issues an access token and an update token. The authorization server 3 in the exemplary embodiment issues an access token and/or an update token in response to a request from another device and sends the issued access token and/or update token to this device in an authorization procedure. The authorization procedure is a procedure for obtaining an access token and includes steps of setting authentication settings with the authorization server 3. As discussed above, when an update token is presented, the authorization server 3 issues an access token corresponding to this update token. Reissuing an access token using an update token does not require the authorization procedure.

In the exemplary embodiment, it is assumed that, for example, the authorization server 3a issues a token for using a service provided by the service server 4a and the authorization server 3b issues a token for using a service provided by the service server 4b. A token issued by the authorization server 3a may be called token A, access token A, or update token A, and a token issued by the authorization server 3b may be called token B, access token B, or update token B so as to distinguish tokens issued by the authorization servers 3 from each other.

The service server 4 is a server that provides a service in response to a request from another device. More specifically, in response to receiving a request for a service from another device and the device presenting a valid access token, the service server 4 provides a service to this device.

The individual service servers 4 provide different services. That is, the service provided by a service server 4 is different from that by another service server 4. In one example, different services refer to different types of services, such as a service for sending a file with an email and a service for storing a file. In another example, even for the same type of service, if a factor of one service is different from that of another service, they are regarded as different services. For example, two service servers 4 provide the same type of service, but if the provider providing the service of one service server 4 is different from that of the other service server 4, this service is regarded as different services.

In the example in FIG. 1, only two service servers 4a and 4b are shown. However, three or more service servers 4 may be provided, in which case, three or more authorization servers 3 may accordingly be provided.

In the exemplary embodiment, it is assumed that, for example, the service servers 4a and 4b are both able to provide a service for sending an email including data received from the external device 2 to a specified destination by using SMTP (Simple Mail Transfer Protocol). Such a service may also be called an email service. Nevertheless, the provider providing the service of the service server 4a is different from that of the service server 4b, and the services provided by the service servers 4a and 4b are considered as different services. Hereinafter, the service servers 4a and 4b may also be called SMTP servers 4a and 4b, and the email service provided by the SMTP server 4a may also be called email service A, while the email service provided by the SMTP server 4b may also be called email service B.

In the exemplary embodiment, the external device 2, which is an image processing device, can provide a user with a function of sending an email including image data generated by scanning to a specified destination by utilizing email service A of the SMTP server 4a or email service B of the SMTP server 4b. Such a function may also be called a scan email function.

### [User Terminal 1]

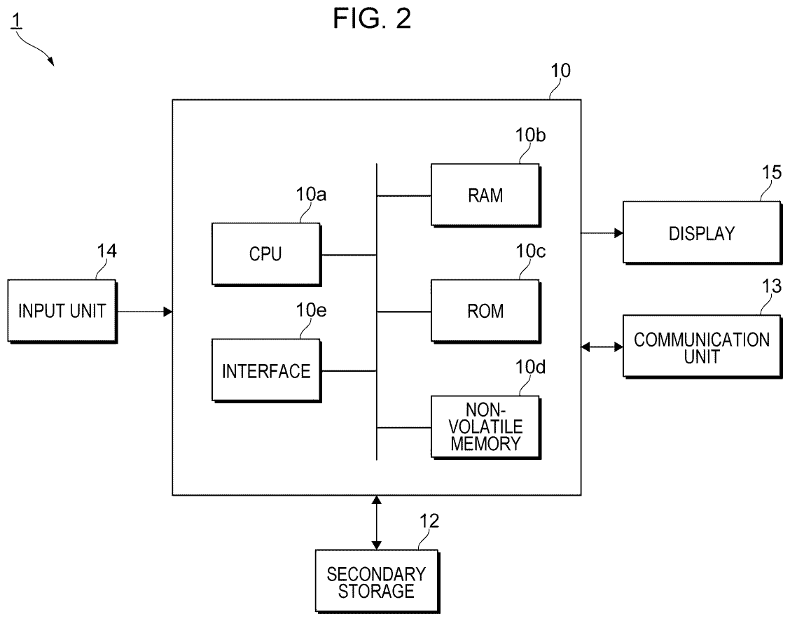

FIG. 2 is a block diagram illustrating an example of the hardware configuration of the user terminal 1.

As illustrated in FIG. 2, the user terminal 1 includes a controller 10, a secondary storage 12, a communication unit 13, an input unit 14, and a display 15. The configuration of the user terminal 1 shown in FIG. 2 is only an example, and the user terminal 1 may also include an imaging device and a sound output device, for example.

The controller 10 executes various types of processing in accordance with a read program so as to control the operation of the user terminal 1. The controller 10 includes a central processing unit (CPU) 10a, which serves as a processor, a random access memory (RAM) 10b used as a work area for the CPU 10a, and a read only memory (ROM) 10c that stores programs executed by the CPU 10a and preset values, for example. The controller 10 also includes a non-volatile memory 10d, which can retain data even after power supply is interrupted, and an interface 10e, which controls various elements connected to the controller 10, such as the communication unit 13. The non-volatile memory 10d is constituted by a battery-powered static RAM (SRAM) or a flash memory, for example.

As a result of the CPU 10a, which is an example of the processor, reading and executing a program, various functions, which will be discussed later, of the user terminal 1 of the exemplary embodiment are implemented.

Various programs to be executed by the CPU 10a may be provided while being stored in a computer readable recording medium, such as a magnetic recording medium (magnetic tape and a magnetic disk, for example), an optical recording medium (optical disc, for example), a magneto-optical recording medium, and a semiconductor memory. A program to be executed by the CPU 10a may be downloaded via a communication medium, such as the internet. The term “processor” refers to hardware in a broad sense. Examples of the processor include general processors (e.g., CPU) and dedicated processors (e.g., GPU: Graphics Processing Unit, ASIC: Application Specific Integrated Circuit, FPGA: Field Programmable Gate Array, and programmable logic device). The term “processor” is broad enough to encompass one processor or plural processors in collaboration which are located physically apart from each other but may work cooperatively. The order of operations of the processor is not limited to one described in embodiments, and may be changed.

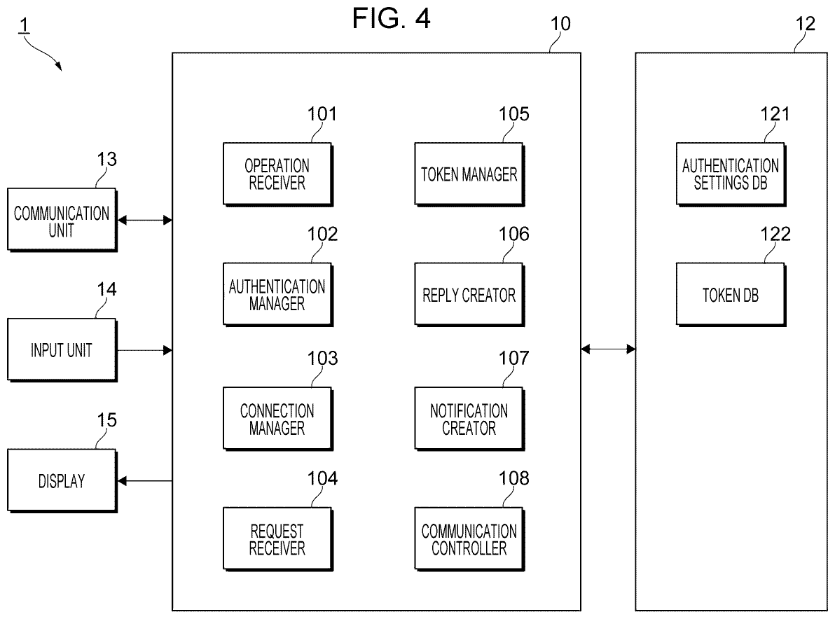

The secondary storage 12 records programs executed by the CPU 10a. The secondary storage 12 also provides databases for storing various items of data used by the user terminal 1, such as information on authentication settings set with the authorization server 3 and access tokens and/or update tokens obtained from the authorization server 3, and records the data stored in the databases. Such databases will be discussed later with reference to FIG. 4. The secondary storage 12 is constituted by a storage device, such as a magnetic disk or a solid state drive (SSD).

The communication unit 13 performs data communication with another device via a network (see FIG. 1). As the communication unit 13, the interface based on the communication method of the network is used. If short distance wireless communication, such as BLE (Bluetooth Low Energy) (registered trademark) and NFC (Near Field Communication), is performed between the user terminal 1 and the external device 2, the communication unit 13 may include a wireless communication interface based on the communication method.

The input unit 14 is a device, such as a hardware button, a switch, a touch sensor, a code reader, and a device such as a sensor reading biological information of a user. The hardware button and the switch receive an input operation from a user. The touch sensor outputs a control signal in accordance with a touching operation performed with a finger, for example. The code reader reads code information, such as barcode and QR code (registered trademark).

The display 15 is constituted by a liquid crystal display or an organic electroluminescence (EL) display, for example, and displays a screen including various types of information, such as images and text. A touch sensor, which is an example of the input unit 14, and the display 15, may be combined with each other and be used as a touchscreen. In this case, software buttons, for example, for receiving an input operation from a user are displayed on the display 15.

### [Hardware Configuration of External Device 2]

FIG. 3 is a block diagram illustrating an example of the hardware configuration of the external device 2.

As illustrated in FIG. 3, the external device 2 includes a controller 20, a secondary storage 22, a communication unit 23, an input unit 24, and a display 25. Since the external device 2 in the exemplary embodiment is an image processing device, it also includes an image former 26 and an image reader 27 as elements related to image processing.

The controller 20, communication unit 23, input unit 24, and display 25 of the external device 2 are respectively similar to the controller 10, communication unit 13, input unit 14, and display 15 of the user terminal 1 discussed with reference to FIG. 2, and an explanation thereof will thus be omitted.

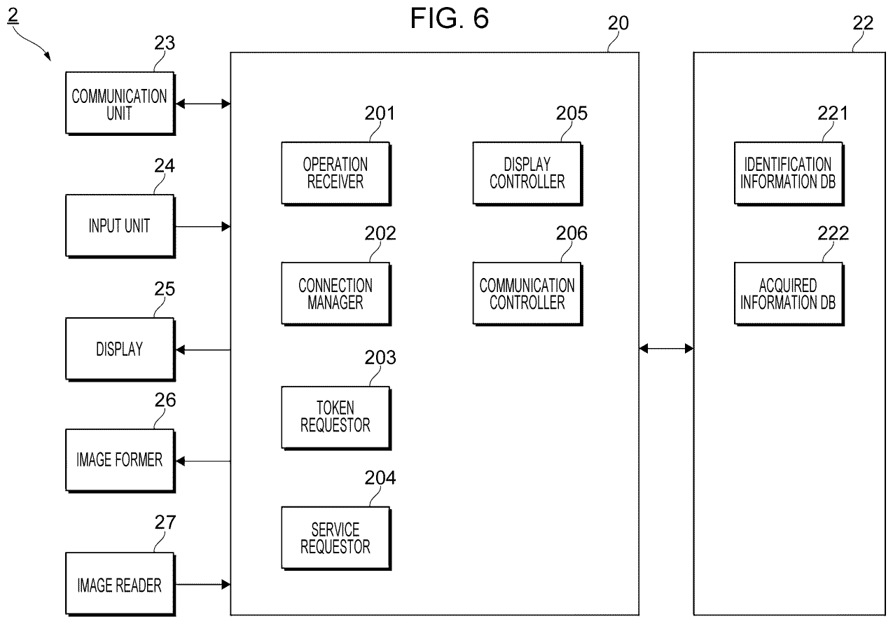

The secondary storage 22 records programs executed by the CPU 20a. The secondary storage 22 also provides databases for storing various items of data used by the external device 2, such as access tokens and update tokens obtained from the user terminal 1, image data used for printing in the image former 26, and image data generated as a result of the image reader 27 reading an image, and records the data stored in the databases. Such databases will be discussed later with reference to FIG. 6. The secondary storage 22 can be constituted by various devices, as in the secondary storage 12 of the user terminal 1.

The image former 26 is constituted by a print engine of a printer, such as a laser printer or an inkjet printer, and forms and prints an image of image data on a recording medium, such as paper, in response to an instruction from the controller 20.

The image reader 27 is constituted by an image scanner, for example, and reads an image formed on a recording medium (document), such as paper, in response to an instruction from the controller 20, and sends the read image to the controller 20 as image data.

### [Hardware Configurations of Authorization Server 3 and Service Server 4]

The authorization server 3 and the service server 4 have a hardware configuration similar to that of the user terminal 1 shown in FIG. 2, for example.

The service server 4 includes various elements required for providing a service.

### [Functional Configuration of User Terminal 1]

FIG. 4 is a block diagram illustrating an example of the functional configuration of the user terminal 1 to which the first exemplary embodiment is applied.

As illustrated in FIG. 4, the user terminal 1 includes an operation receiver 101, an authentication manager 102, a connection manager 103, a request receiver 104, a token manager 105, a reply creator 106, a notification creator 107, and a communication controller 108.

The user terminal 1 also includes, as databases (may be abbreviated as DBs) in the secondary storage 12, an authentication settings DB 121 that stores information on authentication settings and a token DB 122 that stores access tokens and update tokens.

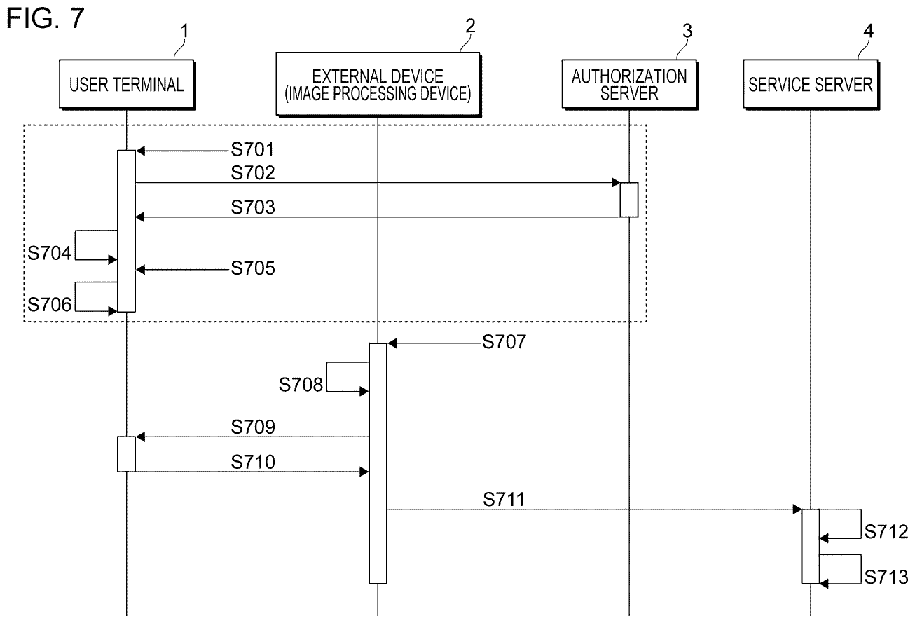

The operation receiver 101 receives various operations input from a user via the input unit 14 (see FIG. 2). In one example, the operation receiver 101 receives information on authentication settings and service information input via the input unit 14. In another example, if the user terminal 1 is used as a remote user interface (UI), which will be discussed later with reference to FIG. 7, the operation receiver 101 receives an operation for selecting a function to be used in the external device 2, for example.

The authentication manager 102 manages authentication settings set between the user terminal 1 (information processing system) and the authorization server 3. The authentication manager 102 links authentication settings, which are set by specifying a service to be provided by the service server 4, with identification information of the specified service. In one specific example, the authentication manager 102 links information on authentication settings, which are set by specifying email service A to be provided by the SMTP server 4a, with identification information of email service A. The authentication manager 102 then stores the information linked with the identification information of email service A in the authentication settings DB 121 of the secondary storage 12 and manages the information. In another specific example, the authentication manager 102 links information on authentication settings, which are set by specifying email service B to be provided by the SMTP server 4b, with identification information of email service B. The authentication manager 102 then stores the information linked with the identification information of email service B in the authentication settings DB 121 of the secondary storage 12 and manages the information.

Additionally, in response to the request receiver 104 receiving a request from the external device 2, the authentication manager 102 extracts information on authentication settings linked with identification information of a specified service from the authentication settings DB 121 and allows for the use of the extracted information for processing to be executed in the user terminal 1 (information processing system).

Identification information is not restricted to a particular type of information if it is information from which the user terminal 1 and the external device 2 can identify a corresponding service. In one example, identification information may be the ID of an individual service, which is registered in the user terminal 1 and the external device 2 in advance to identify a corresponding service. In another example, identification information may be the name of an individual service, the address of a service server 4 providing a service, account information of a service, or an email address used in an email service, which are registered in the user terminal 1 and the external device 2 in advance. As in the exemplary embodiment, if the authorization servers 3 and the service servers 4 are provided based on a one-to-one correspondence, that is, if only one authorization server 3 issues an token for one service server 4, information on the authorization server 3 may be used as identification information. More specifically, the name or the address of the authorization server 3 or an ID and a password used for setting authentication settings may be used as identification information.

In the exemplary embodiment, a description will be given by taking an example in which the name of a service is used as identification information.

As information on authentication settings, various types of information required for setting authentication settings between the user terminal 1 and the authorization server 3 or for executing the authorization procedure may be used: such as a path to an authorization endpoint in the authorization server 3, a path to a token endpoint in the service server 4, an ID and a password requested from the authorization server 3 for setting authentication settings, a scope or redirect URI (Uniform Resource Identifier), and an authorization code issued by the authorization server 3.

The connection manager 103 manages the connection state between the user terminal 1 and the external device 2. The connection state is a state in which the external device 2 and the user terminal 1 recognize each other as their connection partners after the user terminal 1 returns a reply to a connection request sent from the external device 2. That is, the connection state is a state in which the user terminal 1 recognizes the external device 2 as a token requestor and the external device 2 recognizes the user terminal 1 as a token request receiver. The connection manager 103 receives a connection request from the external device 2 and returns a reply to the external device 2 so that the user terminal 1 can identify the external device 2 as a device in the connection state. A connection request and a connection reply may be sent and received as a result of the user terminal 1 and the external device 2 exchanging packets using a short distance wireless communication medium of the communication unit 13 (see FIG. 2) or the user terminal 1 reading code information displayed on the display 25 (see FIG. 3) of the external device 2. Alternatively, a network that connects the devices of the service use system 1000 (see FIG. 1) may be used for sending and receiving a connection request and a connection reply.

The request receiver 104 receives a request for a token from the external device 2. More specifically, the request receiver 104 of the exemplary embodiment receives a request for a token from the external device 2 which is in the connection state and performs control to execute processing, such as creation of a reply, which will be discussed later, in response to the received request. Making a request for a token includes specifying of a service to be used. A service can be specified with the use of identification information similar to that used by the authentication manager 102 or the token manager 105.

The request receiver 104 also stores a record of a token request received from the external device 2 in the database of the secondary storage 12 and manages the record.

The token manager 105 links a token obtained from the authorization server 3 with identification information of a corresponding service and manages the token linked with the identification information. As discussed above, the authorization server 3 of the exemplary embodiment issues both of an access token and an update token. The token manager 105 thus links the obtained access token and update token with identification information of a corresponding service and manages these tokens linked with the identification information.

As in a token linked with identification information of a service, the token manager 105 of the exemplary embodiment also links service information, which is provided by the external device 2 to the service server 4 to use a service and is used by the service server 4, with identification information of a corresponding service and manages the service information linked with the identification information. Examples of service information are an email address, a port number, and an encryption method required for using email service A or B.

For each service, the token manager 105 of the exemplary embodiment integrates information, such as identification information, an access token, an update token, and service information, linked with a service into an information management table within the token DB 122 and manages the integrated information.

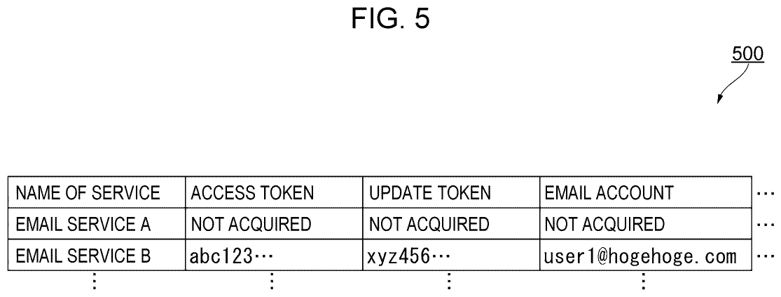

FIG. 5 illustrates an information management table 500 as an example of such an information management table.

In the information management table 500, information of email service A is stored in the first row, and information of email service B is stored in the second row. As discussed above, the name of a service is used as identification information in the exemplary embodiment. Hence, the access token (abc123 . . . ), the update token (xyz456 . . . ), and service information, such as an email account (user1@hogehoge.com), for example, are linked with the name of “email service B” and are managed. In the example in FIG. 5, authentication settings and service information for email service A are not yet registered, and the fields of the access token, update token, and email account indicate “not acquired”. When authentication settings and service information for email service A are registered, they are linked with the name of “email service A” and are added to the information management table 500 and are managed.

In response to the request receiver 104 receiving a request for a token from the external device 2, the token manager 105 extracts tokens and service information linked with identification information of a specified service from the token DB 122 and allows for the use of the extracted information for another processing.

The token manager 105 of the exemplary embodiment also sends a request for an access token and an update token to the authorization server 3 by utilizing authentication settings set between the user terminal 1 (information processing system) and the authorization server 3. The token manager 105 also sends a request for an access token to the authorization server 3 by using an update token. As a result of the authorization server 3 issuing tokens in response to these requests, the tokens to be managed by the token manager 105 are obtained. The token manager 105 may also update or delete expired access tokens and update tokens among tokens managed by the token manager 105.

The reply creator 106 creates a reply including a token of a specified service as a reply to a request for a token received from the external device 2. More specifically, by setting the external device 2 as a reply receiver, the reply creator 106 creates a reply including a token and service information, which are extracted by the token manager 105 in response to a request for a token from the external device 2.

The notification creator 107 creates various notifications to be sent to another device. If, for example, the user terminal 1 has failed to obtain a token from the authorization server 3 for some reason or to send an obtained token to the external device 2, the notification creator 107 creates an error notification indicating such information by setting the external device 2 or the terminal of the administrator of the external device 2 as a notification receiver. If, for example, a certain operation or work of a user of the user terminal 1 who uses the external device 2 or the administrator of the external device 2 is required, the notification creator 107 creates a notification indicating a request for such an operation or work.

The communication controller 108 controls data communication performed by the communication unit 13 (see FIG. 2). In one example, the communication controller 108 performs control to send a reply including a token of a specified service created by the reply creator 106 to the external device 2 having sent a request for the token. In another example, the communication controller 108 performs control to send various notifications created by the notification creator 107 or a request for various items of data to be used in the user terminal 1 (information processing system) to another device, such as the external device 2.

The communication controller 108 also extracts required information from data received from another device and allows for the use of the extracted information in a corresponding function. In a specific example, the communication controller 108 extracts information related to a request for a token from data received from the external device 2 and allows the use of the extracted information in the request receiver 104.

### [Functional Configuration of External Device 2]

FIG. 6 is a block diagram illustrating an example of the functional configuration of the external device 2.

As illustrated in FIG. 6, the external device 2 includes an operation receiver 201, a connection manager 202, a token requestor 203, a service requestor 204, a display controller 205, and a communication controller 206.

The external device 2 also includes, as databases in the secondary storage 22, an identification information DB 221 that stores identification information of services and an acquired information DB 222 that stores acquired access tokens and update tokens and service information.

The operation receiver 201 receives various operations input from a user via the input unit 24 (see FIG. 3). In one example, the operation receiver 201 receives an operation for selecting one of various functions to be provided to a user by the external device 2, such as a scan email function, and for making a request for the use of the selected function. In another example, the operation receiver 201 receives operations for inputting and registering various items of information by a user and the administrator.

The connection manager 202 manages the connection state between the external device 2 and the user terminal 1. The connection manager 202 sends a connection request to the user terminal 1 and receives a reply from the user terminal 1 so as to identify the user terminal 1 as a device in the connection state.

The connection manager 202 also cancels the connection state with the user terminal 1 at a predetermined timing, such as a timing at which the use of a service using a token provided by the user terminal 1 has finished. The connection manager 202 also cancels the connection state with the user terminal 1 when a reply is not received from the user terminal 1 within a preset time (when a timeout occurs).

The token requestor 203 creates, as a request to the user terminal 1 in the connection state, a request for a token including identification information of a specified service. More specifically, in response to the operation receiver 201 receiving the selection of a function from a user, for example, the token requestor 203 creates a request for a token including identification information of a specified service, which is required for executing the function. A request for a token may also include a request for service information of a specified service.

If the external device 2 stores an update token, the token requestor 203 of the exemplary embodiment may be able to request the authorization server 3 to issue an access token by using the update token.

The service requestor 204 creates a request for the use of a service to the service server 4. A request for the use of a service includes data to be used by a service of the service server 4, such as image data created by a scanning operation in the external device 2 and to be used by an email service, for example. A request for the use of a service also includes service information received from the user terminal 1, information for identifying the external device 2 which sends the request, and information for specifying the service server 4 which receives the request.

The service requestor 204 also links the created request for the use of a service with a corresponding access token.

The display controller 205 controls the types of information, such as images, icons, and text, and the content of information to be displayed on the display 25 and also controls a display mode, such as the position and the size of an image to be displayed.

The display controller 205 performs control, for example, to display a screen for instructing a user to select a function available in the external device 2. The display controller 205 also performs control, for example, to display a notification screen for presenting the content of a notification received from the user terminal 1 to a user.

The communication controller 206 controls data communication performed by the communication unit 23 (see FIG. 3). In one example, the communication controller 206 performs control to send a request for a token created by the token requestor 203 to the user terminal 1 which is in the connection state. In another example, the communication controller 206 also performs control to send a request for the use of a service created by the service requestor 204 and an access token linked with the request to the service server 4.

### [Use of Service]

An overview of a procedure for using a service in the service use system 1000 will now be described below with reference to FIGS. 1 through 7.

FIG. 7 is a sequence diagram illustrating an example of the operation of the service use system 1000.

An explanation will be given with reference to FIG. 7. In step S701, the user terminal 1 receives an operation for a request for setting authentication settings from a user, for example. In step S702, the user terminal 1 then sends a request for authorization to the authorization server 3. In one specific example, to set authentication settings for obtaining token A of email service A, for example, the user terminal 1 sends a request for authorization to the authorization server 3a. In another specific example, to set authentication settings for obtaining token B of email service B, for example, the user terminal 1 sends a request for authorization to the authorization server 3b. In this case, information required for setting authentication settings, such as an ID and a password for a service, is input and is sent to the authorization server 3. In step S703, the authorization server 3 authorizes the user terminal 1 based on the request for authorization and sends a token and information on authentication settings to the user terminal 1. In step S704, the user terminal 1 links the obtained token and information on authentication settings with identification information of a corresponding service and stores them.

In step S705, service information is registered in the user terminal 1. In step S706, the user terminal 1 stores the registered service information.

Steps S701 through S704 are steps regarding authentication settings between the user terminal 1 and the authorization server 3. In the exemplary embodiment, once authentication settings are set between the user terminal 1 and the authorization server 3, information on the authentication settings is stored in the user terminal 1. Thereafter, the stored information of the authentication settings is used, and it is not necessary to set authentication settings again.

Steps S705 and S706 are steps regarding the registration of service information in the user terminal 1. The registered service information is stored in the user terminal 1, and reregistration of the service information is not required.

That is, regarding steps S701 through S706 defined by the broken lines in FIG. 7, it is not necessary to repeat them every time a service is used in the service use system 1000, but they are executed only once when, for example, a service is used for the first time. Thereafter, a service can be used by executing steps S707 through S713.

Referring back to FIG. 7, in step S707, the external device 2 receives the selection of a function from a user. In this example, the external device 2 receives an operation for a request for the use of a scan email function.

In step S708, the external device 2 scans a document set by the user and creates image data to be used in the scan email function.

In step S709, the external device 2 specifies a service corresponding to the selected function and sends a request for a token to the user terminal 1.

The service use system 1000 according to the exemplary embodiment includes the SMTP servers 4a and 4b providing the same type of service, and more specifically, the SMTP server 4a providing email service A and the SMTP server 4b providing email service B. The external device 2 uses one of email service A and email service B when executing the scan email function. In this case, in one example, the external device 2 receives the selection made by a user regarding whether to use email service A or email service B and sends a request for a token of the selected service as a specified service. In another example, the administrator of the external device 2 presets the priority order of email services or restricts the use of some email services and sends a request for a token of an email service having a higher priority or an email service whose use is not restricted as a specified service. In a mode in which the priority order is set, if, for some reason, the external device 2 has failed to obtain a token of a specified service having a higher priority, it may specify a service having the next higher priority and send a request for a token of this service.

Referring back to FIG. 7, in step S710, the user terminal 1 returns a reply including a token of the specified service and service information to the external device 2. More specifically, if email service A is specified, the user terminal 1 returns a reply including token A, and if email service B is specified, the user terminal 1 returns a reply including token B. In this manner, a token is provided from the user terminal 1 to the external device 2. The user terminal 1 may reobtain a token of a specified service from the corresponding authorization server 3 before creating a reply, depending on whether a valid token is stored. This will be discussed later in detail.

In step S711, the external device 2 sends a request for the use of the specified service to the corresponding service server 4 by utilizing the token provided from the user terminal 1. More specifically, an access token is provided from the user terminal 1 in the first exemplary embodiment, and the external device 2 thus sends a request for the use of the service to the service server 4 by utilizing the provided access token and service information. If an update token only is provided, the external device 2 obtains an access token by using the provided update token and then sends a request for the use of the service to the service server 4 by utilizing the obtained access token and service information. This mode will be discussed later as a second exemplary embodiment. In the exemplary embodiment, such a request for the use of a service includes image data to be used in an email service.

In step S712, the service server 4 verifies the access token included in the request for the use of the service sent from the external device 2. If the access token is found to be valid, in step S713, the service server 4 executes the service by using the service information and image data included in the request. In this example, the service server 4 sends the image data included in the request to a specified destination by email.

### [Operation of User Terminal 1]

As stated above, the user terminal 1 to which the first exemplary embodiment is applied provides an access token of a specified service in response to a request for a token from the external device 2.

The operation for providing an access token by the user terminal 1 of the first exemplary embodiment will now be described below in detail. The operation described below corresponds to the operation of the user terminal 1 in step S710 in FIG. 7.

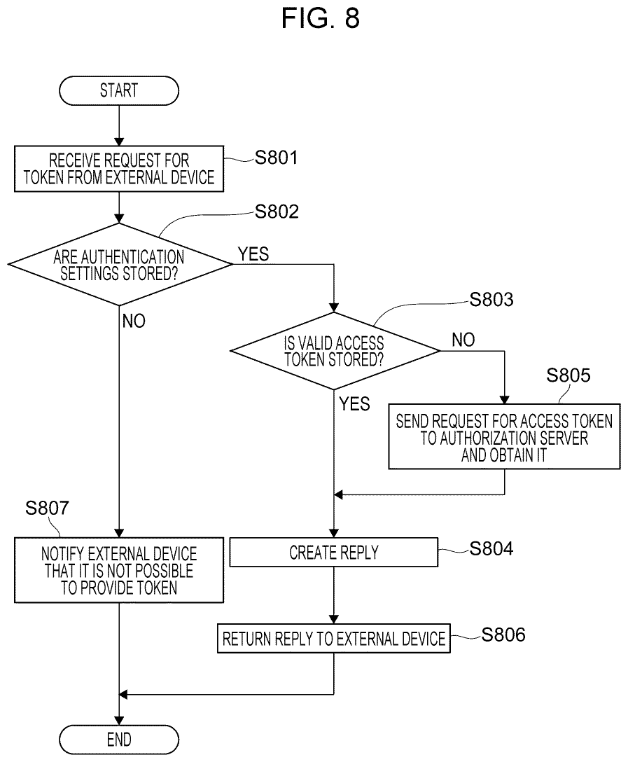

FIG. 8 is a flowchart illustrating an example of the operation for providing an access token by the user terminal 1 to which the first exemplary embodiment is applied.

In step S801, the user terminal 1 receives a request for a token from the external device 2. Then, in step S802, based on identification information of a specified service included in the request for a token and information managed by the authentication settings DB 121, the user terminal 1 determines whether information on authentication settings for the specified service is stored. If information on authentication settings for the specified service is stored (YES in step S802), based on the identification information of the specified service and information managed by the token DB 122, the user terminal 1 determines in step S803 whether a valid access token of the specified service is stored. If a valid access token is stored (YES in step S803), the user terminal 1 creates a reply including the access token and service information in step S804. If a valid access token is not stored (NO in step S803), the user terminal 1 sends a request for an access token to the corresponding authorization server 3 by using the update token and obtains an access token from the authorization server 3 in step S805. Then, in step S804, the user terminal 1 creates a reply including the obtained access token and service information. In step S806, the user terminal 1 returns the reply created in step S804 to the external device 2.

If information on authentication settings for the specified service is not stored (NO in step S802), the user terminal 1 of the first exemplary embodiment notifies the external device 2 in step S807 that it is not possible to provide a token.

As a result of executing the operation of S801 through S807, processing for providing an access token by the user terminal 1 is completed.

As described above, the user terminal 1 of the first exemplary embodiment manages an access token and an update token as tokens linked with identification information. In response to receiving a request for a token from the external device 2, if the user terminal 1 stores a valid access token of a specified service, it returns a reply including this access token to the external device 2.

If the user terminal 1 does not store a valid access token of a specified service, it obtains an access token of the specified service from the authorization server 3 by using an update token and returns a reply including the obtained access token to the external device 2.

The user terminal 1 of the first exemplary embodiment manages both of an access token and an update token. The user terminal 1 may thus return a reply including both of an access token and an update token of a specified service to the external device 2. This enables the external device 2 to obtain an access token from the authorization server 3 by using the update token. Even if the access token provided by the user terminal 1 expires later, the external device 2 is able to obtain a new access token by itself and use a service. That is, the next time the external device 2 uses the service, it can obtain an access token from the authorization server 3 without connecting to the user terminal 1.

### Second Exemplary Embodiment

In the above-described first exemplary embodiment, the user terminal 1 returns a reply including an access token of a specified service in response to a request for a token from the external device 2. In a second exemplary embodiment, a user terminal returns a reply including an update token of a specified service in response to a request for a token from the external device 2. The external device 2 then obtains an access token from the authorization server 3 by utilizing the update token provided by the user terminal and uses a service by using the obtained access token.

Hereinafter, the second exemplary embodiment will be described below in detail with reference to FIGS. 1 through 7 and 9. Part of the operation of the user terminal 1 and part of the operation of the external device 2 of the second exemplary embodiment are different from those of the first exemplary embodiment, and the configurations of the individual devices (see FIGS. 1 through 6) and an overview of the procedure for using a service (see FIG. 7) of the second exemplary embodiment are the same as those of the first exemplary embodiment. In the second exemplary embodiment, elements similar to those in the first exemplary embodiment are designated by like reference numerals and an explanation thereof will thus be omitted. Regarding the user terminal, the user terminal used in the second exemplary embodiment is designated by a user terminal 1′ and is distinguished from the user terminal 1 of the first exemplary embodiment. That is, in the second exemplary embodiment, the user terminal 1 in FIGS. 1 through 7 is replaced by the user terminal 1′.

### Operation Example of User Terminal 1′

The operation for providing an update token by the user terminal 1′ of the second exemplary embodiment will be explained below in detail. The operation described below corresponds to the operation of the user terminal 1′ in step S710 in FIG. 7.

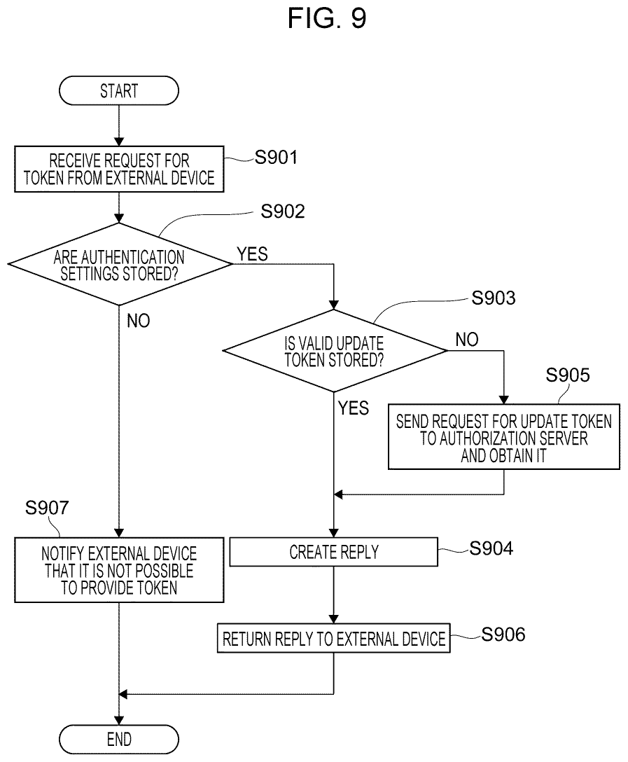

FIG. 9 is a flowchart illustrating an example of the operation for providing an update token by the user terminal 1′ to which the second exemplary embodiment is applied.

In step S901, the user terminal 1′ receives a request for a token from the external device 2. Then, in step S902, based on identification information of a specified service included in the request for a token and information managed by the authentication settings DB 121, the user terminal 1′ determines whether information on authentication settings for the specified service is stored. If information on authentication settings for the specified service is stored (YES in step S902), based on the identification information of the specified service and information managed by the token DB 122, the user terminal 1′ determines in step S903 whether a valid update token of the specified service is stored. If a valid update token is stored (YES in step S903), the user terminal 1′ creates a reply including the update token and service information in step S904. If a valid update token is not stored (NO in step S903), the user terminal 1′ sends a request for an update token to the corresponding authorization server 3 by using the information on the authentication settings and obtains an update token from the authorization server 3 in step S905. Then, in step S904, the user terminal 1′ creates a reply including the obtained update token and service information. In step S906, the user terminal 1′ returns the reply created in step S904 to the external device 2.

If information on authentication settings for the specified service is not stored (NO in step S902), the user terminal 1′ notifies the external device 2 in step S907 that it is not possible to provide a token.

As a result of executing the operation of S901 through S907, processing for providing an update token by the user terminal 1′ is completed.

As described above, the user terminal 1′ of the second exemplary embodiment manages at least an update token as a token linked with identification information. In response to receiving a request for a token from the external device 2, if the user terminal 1′ stores a valid update token of a specified service, it returns a reply including this update token to the external device 2.

The user terminal 1′ of the second exemplary embodiment manages an update token and an access token as tokens linked with identification information. If the user terminal 1′ stores a valid update token of a specified service, it may return a reply including both of the update token and an access token of the specified service to the external device 2. If the user terminal 1′ does not store a valid access token, it may first obtain an access token by using the update token and return a reply including the update token and the obtained access token to the external device 2. Nonetheless, if the user terminal 1′ provides only an update token to the external device 2, the amount of communication between the user terminal 1′ and the external device 2 can be reduced.

Each of the above-described user terminal 1 of the first exemplary embodiment and user terminal 1′ of the second exemplary embodiment can be interpreted as an example of the following information processing system. The information processing system links an access token and/or an update token with identification information of a corresponding service and manages the access token and/or the update token linked with the identification information. The information processing system receives a request for a token, the request including identification information of a specified service, from the external device 2, and if the information processing system stores a valid token as a token of the specified service, it returns a reply including the token of the specified service to the external device 2.

### (Modified Examples and Others)

Exemplary embodiments of the disclosure have been discussed above. However, the technical scope of the disclosure is not limited to a range of description of the first and second exemplary embodiments. Various changes or improvements made to the exemplary embodiments without departing from the scope and the spirit of the disclosure are also encompassed in the disclosure.

For example, in the first and second exemplary embodiments, both of the service servers 4a and 4b provide email services. However, the service provided by a service server is not limited to a particular type, and also, the service servers 4a and 4b may provide different types of services. Additionally, in the first and second exemplary embodiments, as an example, the external device 2 is an image processing device and image data generated by a scanning operation of the external device 2 is used in a service. However, the type of external device 2 and the type of data used in a service are not limited to particular types, and various types of data stored in the external device 2 may be used in a service.

In the first and second exemplary embodiments, service information is managed by the user terminals 1 and 1′ and is provided to the external device 2 together with a token. However, this configuration is only an example, and required service information may be stored in the external device 2. Nonetheless, providing service information from the user terminals 1 and 1′ to the external device 2 can save the time and effort of registration of service information in the external device 2.

In the first and second exemplary embodiments, if information on authentication settings for a specified service is not stored, the user terminals 1 and 1′ notify the external device 2 that it is not possible to provide a token (see S807 in FIGS. 8 and S907 in FIG. 9). In this case, the user terminals 1 and 1′ may alternatively notify the external device 2 that they do not store information on authentication settings for a specified service. In response to such a notification, for example, the external device 2 displays various types of information on the display 25 (see FIG. 3) to let a user know that it is not possible to obtain a token or information on authentication settings is not stored. As an alternative measure to obtain a token, the external device 2 may obtain a token from the authorization server 3 by utilizing authentication settings between the external device 2 and the authorization server 3 set by the administrator, for example. In this manner, as a result of the user terminals 1 and 1′ notifying the external device 2 that it is not possible to obtain a token or information on authentication settings is not stored, the external device 2 can execute various types of processing to handle this situation.

In the first and second exemplary embodiments, one service is specified in a request for a token sent from the external device 2 to the user terminal 1 or 1′. However, the number of services to be specified is not limited to one, and multiple services may be specified. For example, if multiple services of the same type, such as email service A and email service B used in the exemplary embodiment, are available and the external device 2 may use any of the services, the external device 2 may specify all the services and send a request for these services. In this case, the user terminal 1 or 1′ may provide tokens of all the services if possible or provide tokens stored in the user terminal 1 or 1′ (information processing system) only. Alternatively, the user terminal 1 or 1′ may receive the selection made by a user regarding for which services tokens are to be provided and provide the tokens of the selected services only.

In the first and second exemplary embodiments, the user terminals 1 and 1′ decide which one of an access token and an update token is to be provided to the external device 2. Alternatively, the user terminals 1 and 1′ or the external device 2 may receive the selection made by a user regarding which one of an access token and an update token is to be provided and the user terminals 1 and 1′ provide the selected token to the external device 2. The user may be allowed to select both of an access token and an update token. With this configuration, a user can decide whether to select an access token and/or an update token by considering various conditions, such as the storage situation of tokens in the user terminal 1 or 1′, the storage space of the external device 2, and the risk caused by a possible leakage of a token.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
at least one processor configured to:
   link a token to be used for accessing a service with identification information for identifying the service and manage the token and the identification information linked with each other; and
   return, when a request for a token is received from an external device, the request including identification information of a specified service, and if a valid token of the specified service is stored, a reply including the token of the specified service.
      (((2)))

The information processing system according to (((1))), wherein the at least one processor is configured to obtain in advance the token to be linked with the identification information based on authentication settings set between the information processing system and an authorization server and to link information on the authentication settings with the identification information and manage the information on the authentication settings and the identification information linked with each other.

(((3)))

The information processing system according to (((2))), wherein the at least one processor is configured to notify, when the request is received from the external device and if neither of a valid token of the specified service nor information on authentication settings for the valid token are stored, the external device that it is not possible to provide the token of the specified service.

(((4)))

The information processing system according to one of (((1))) to (((3))), wherein the at least one processor is configured to:
manage an access token and an update token as the token to be linked with the identification information, the access token being a token to be presented to a service server that provides a service when access is made to the service, the update token being a token to be presented to an authorization server in order to obtain the access token; and
return, if a valid access token of the specified service is stored, a reply including the access token of the specified service to the external device.
   (((5)))

The information processing system according to (((4))), wherein the at least one processor is configured to obtain, if a valid access token of the specified service is not stored, an access token of the specified service by using a corresponding update token and return a reply including the obtained access token of the specified service to the external device.

(((6)))

The information processing system according to one of (((1))) to (((3))), wherein the at least one processor is configured to:
manage an update token as the token to be linked with the identification information, the update token being a token to be presented to an authorization server in order to obtain an access token, the access token being a token to be presented to a service server that provides a service when access is made to the service; and
return, if a valid update token of the specified service is stored, a reply including the update token of the specified service to the external device.
   (((7)))

The information processing system according to (((6))), wherein the at least one processor is configured to:
manage the update token and the access token as the token to be linked with the identification information; and
return, if a valid update token of the specified service is stored, a reply including both of the update token and the access token of the specified service to the external device.
   (((8)))

The information processing system according to one of (((1))) to (((7))), wherein the at least one processor is configured to:
link service information to be used by a service server that provides a service with the identification information and manage the service information and the identification information linked with each other; and
include the service information of the specified service to the reply including the token of the specified service to be returned to the external device.
   (((9)))

A program causing a computer to execute a process, the process comprising:
linking a token to be used for accessing a service with identification information for identifying the service and managing the token and the identification information linked with each other; and
returning, when a request for a token is received from an external device, the request including identification information of a specified service, and if a valid token of the specified service is stored, a reply including the token of the specified service.

What is claimed is:

1. An information processing system comprising:
at least one processor configured to:
link a token to be used for accessing a service with identification information for identifying the service and manage the token and the identification information linked with each other; and
return, when a request for a token is received from an external device, the request including identification information of a specified service, and if a valid token of the specified service is stored, a reply including the token of the specified service.

2. The information processing system according to claim 1, wherein the at least one processor is configured to obtain in advance the token to be linked with the identification information based on authentication settings set between the information processing system and an authorization server and to link information on the authentication settings with the identification information and manage the information on the authentication settings and the identification information linked with each other.

3. The information processing system according to claim 2, wherein the at least one processor is configured to notify, when the request is received from the external device and if neither of a valid token of the specified service nor information on authentication settings for the valid token are stored, the external device that it is not possible to provide the token of the specified service.

4. The information processing system according to claim 1, wherein the at least one processor is configured to:
manage an access token and an update token as the token to be linked with the identification information, the access token being a token to be presented to a service server that provides a service when access is made to the service, the update token being a token to be presented to an authorization server in order to obtain the access token; and
return, if a valid access token of the specified service is stored, a reply including the access token of the specified service to the external device.

5. The information processing system according to claim 2, wherein the at least one processor is configured to:
manage an access token and an update token as the token to be linked with the identification information, the access token being a token to be presented to a service server that provides a service when access is made to the service, the update token being a token to be presented to an authorization server in order to obtain the access token; and
return, if a valid access token of the specified service is stored, a reply including the access token of the specified service to the external device.

6. The information processing system according to claim 3, wherein the at least one processor is configured to:
manage an access token and an update token as the token to be linked with the identification information, the access token being a token to be presented to a service server that provides a service when access is made to the service, the update token being a token to be presented to an authorization server in order to obtain the access token; and
return, if a valid access token of the specified service is stored, a reply including the access token of the specified service to the external device.

7. The information processing system according to claim 4, wherein the at least one processor is configured to obtain, if a valid access token of the specified service is not stored, an access token of the specified service by using a corresponding update token and return a reply including the obtained access token of the specified service to the external device.

8. The information processing system according to claim 5, wherein the at least one processor is configured to obtain, if a valid access token of the specified service is not stored, an access token of the specified service by using a corresponding update token and return a reply including the obtained access token of the specified service to the external device.

9. The information processing system according to claim 6, wherein the at least one processor is configured to obtain, if a valid access token of the specified service is not stored, an access token of the specified service by using a corresponding update token and return a reply including the obtained access token of the specified service to the external device.

10. The information processing system according to claim 1, wherein the at least one processor is configured to:
manage an update token as the token to be linked with the identification information, the update token being a token to be presented to an authorization server in order to obtain an access token, the access token being a token to be presented to a service server that provides a service when access is made to the service; and
return, if a valid update token of the specified service is stored, a reply including the update token of the specified service to the external device.

11. The information processing system according to claim 2, wherein the at least one processor is configured to:
manage an update token as the token to be linked with the identification information, the update token being a token to be presented to an authorization server in order to obtain an access token, the access token being a token to be presented to a service server that provides a service when access is made to the service; and
return, if a valid update token of the specified service is stored, a reply including the update token of the specified service to the external device.

12. The information processing system according to claim 3, wherein the at least one processor is configured to:
manage an update token as the token to be linked with the identification information, the update token being a token to be presented to an authorization server in order to obtain an access token, the access token being a token to be presented to a service server that provides a service when access is made to the service; and
return, if a valid update token of the specified service is stored, a reply including the update token of the specified service to the external device.

13. The information processing system according to claim 10, wherein the at least one processor is configured to:
manage the update token and the access token as the token to be linked with the identification information; and
return, if a valid update token of the specified service is stored, a reply including both of the update token and the access token of the specified service to the external device.

14. The information processing system according to claim 11, wherein the at least one processor is configured to:
manage the update token and the access token as the token to be linked with the identification information; and
return, if a valid update token of the specified service is stored, a reply including both of the update token and the access token of the specified service to the external device.

15. The information processing system according to claim 12, wherein the at least one processor is configured to:
manage the update token and the access token as the token to be linked with the identification information; and
return, if a valid update token of the specified service is stored, a reply including both of the update token and the access token of the specified service to the external device.

16. The information processing system according to claim 1, wherein the at least one processor is configured to:
link service information to be used by a service server that provides a service with the identification information and manage the service information and the identification information linked with each other; and
include the service information of the specified service to the reply including the token of the specified service to be returned to the external device.

17. An information processing method comprising:
linking a token to be used for accessing a service with identification information for identifying the service and managing the token and the identification information linked with each other; and
returning, when a request for a token is received from an external device, the request including identification information of a specified service, and if a valid token of the specified service is stored, a reply including the token of the specified service.

18. A non-transitory computer readable medium storing a program causing a computer to execute a process, the process comprising:
linking a token to be used for accessing a service with identification information for identifying the service and managing the token and the identification information linked with each other; and
returning, when a request for a token is received from an external device, the request including identification information of a specified service, and if a valid token of the specified service is stored, a reply including the token of the specified service.
